(19) United States
(12) Patent Application Publication
(10) Pub. No.: US 2005/0230058 A1
(43) Pub. Date: Oct. 20, 2005

(54) Irrigation drip tape splicing tool

(76) Inventor: David Karl Stroup, El Cajon, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/082,612

(22) Filed: Mar. 17, 2005

Related U.S. Application Data
(60) Provisional application No. 60/558,795, filed on Mar. 31, 2004.

(51) Int. Cl. B32B 31/00

(52) U.S. Cl. 156/583.1

(57) ABSTRACT

A splicing tool includes a first heated anvil, a second heated anvil, and a mechanism for moving the second heated anvil into contact with the first heated anvil. The first anvil is supported by a base. The second heated anvil is supported for movement with respect to the first heated anvil by post, which is supported by the base. In one embodiment, the post supports a first bracket. A second bracket is movably coupled to the first bracket. A plunger is movably coupled to the second bracket. The second heated anvil is carried by the plunger. A spring is compressed between the first and second bracket. The spring controls the amount of force applied between the first and second heated brackets. The compression of the spring may be adjustable.

### CROSS-REFERENCES TO RELATED APPLICATIONS

The present application claims priority to U.S. provisional patent application Ser. No. 60/558,795 entitled IRRIGATION DRIP TAPE SPLICING TOOL filed on Mar. 31, 2004, which is incorporated herein by reference in its entirety.

### BACKGROUND OF THE INVENTION

The present invention relates generally to splicing tools and more particularly to a tool for heat splicing articles such as irrigation drip tape.

The use of irrigation drip tape has become a popular means of irrigating crops. Irrigation drip tape comprises a perforated hose that is essentially flat when it is not pressured. When water pressure is applied to the tape, it becomes cylindrical and emits drops of water along its length. Irrigation drip is very efficient and environmentally beneficial in that most of the water is delivered to the plants with essentially none being lost to run off.

Another advantage of irrigation drip tape is that it can be spliced together using heat and pressure. Lengths of tape can be connected together to make long runs. If a section of tape becomes cut or otherwise damaged, the damaged portion can be cut out and then a new section of tape can be spliced into the gap. The ability to splice irrigation drip tape also makes it possible to reuse tape recovered from the field.

There is a need for an efficient portable tool for splicing irrigation drip tape in the field.

### BRIEF SUMMARY OF THE INVENTION

A splicing tool includes a first heated anvil, a second heated anvil, and a mechanism for moving the second heated anvil into contact with the first heated anvil. The first anvil is supported by a base. The second heated anvil is supported for movement with respect to the first heated anvil by post, which is supported by the base. In one embodiment, the post supports a first bracket. A second bracket is movably coupled to the first bracket. A plunger is movably coupled to the second bracket. The second heated anvil is carried by the plunger. A spring is compressed between the first and second bracket. The spring controls the amount of force applied between the first and second heated brackets. The compression of the spring may be adjustable.

### BRIEF DESCRIPTION OF THE DRAWINGS

FIG. 1 is a perspective view of a irrigation drip tape splicing tool according to the present invention.

### DETAILED DESCRIPTION OF THE INVENTION

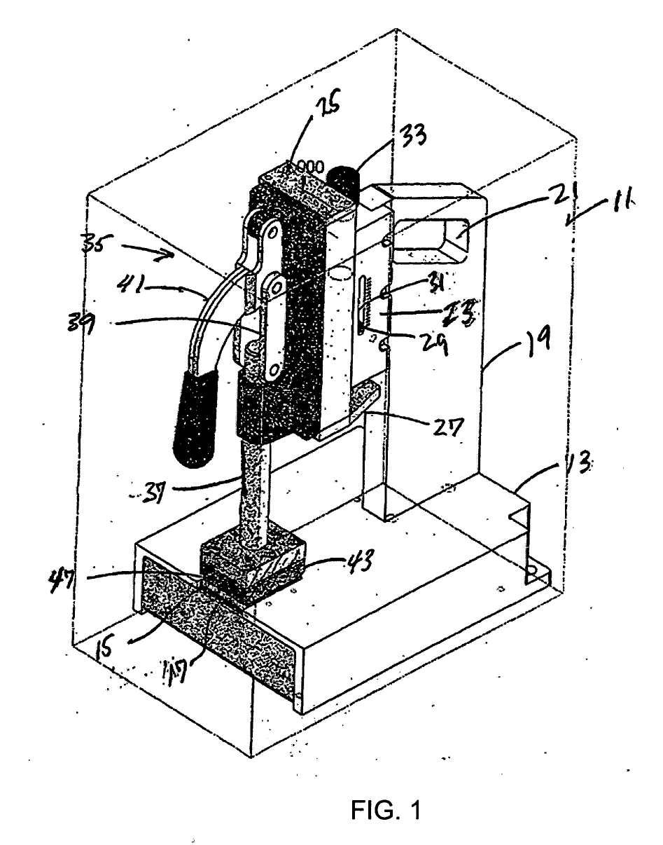

Referring now to FIG. 1, a irrigation drip tape splicing tool is designated generally by the numeral 11. Tool 11 includes a base 13 that supports a first anvil 15. First anvil 15 is preferably fabricated from a heat-resistant material such as fiberglass. First anvil 15 includes internal passages that contain electrical heating elements (not shown). A metallic heating strip 17 is positioned on the upper surface of first anvil 15 in heat conducting contact with the heating elements.

Base 13 supports a post 19. Post 19 conveniently includes a cut-out 21 that forms a handle for carrying tool 11. Post 19 supports a first bracket 23. First bracket 23 is movably connected to a second bracket 25. In one embodiment, each bracket 23 and 25 includes complementary channels that engage rods that connect brackets 23 and 25 together and facilitate their sliding axially with respect to each other.

Second bracket 25 includes a fixed spring plate 27 that extends toward, and is positioned beneath, first bracket 23. First bracket 23 is box-like, and it contains a spring plate (not shown). The spring plate includes a circular plate and a tab 29 that slidingly, but non-rotationally, engages an elongated window 31 in first bracket 23. A spring (not shown) is compressed between spring plate 27 of second bracket 25 and the spring plate of first bracket 23. An adjustment screw 33 is treadedly engaged with first bracket 23. Adjustment screw 33 has an end (not shown) that engages the spring plate of first bracket 23. Adjustment screw 33 allows the compression of the spring to be adjusted. The compression of the spring is indicated by the position of tab 29 in window 31.

Second bracket 25 supports a plunger assembly designated generally by the numeral 35. Plunger assembly 35 includes a plunger 37 that is mounted for axial movement with respect to second bracket 25. Plunger 37 is coupled through a linkage 39 to an operating handle 41 moveably connected to second bracket 25. As will be apparent to those skilled in the art, plunger 37 is movable from the extended position shown in FIG. 1 to a retracted position (not shown) by lifting handle 41.

Plunger 37 carries a second anvil 43. Second anvil 43 is of essentially the same construction as first anvil 15. Second anvil 43 is preferably fabricated from a heat-resistant material such as fiberglass. Second anvil 43 includes internal passages that contain electrical heating elements (not shown). A metallic heating strip 45 is positioned on the lower surface of second anvil 43 in heat conducting contact with the heating elements. Preferably, heating strips 17 and 47 are covered with a tape (not shown) that will prevent the irrigation drip tape from sticking to the heating elements during operation.

In operation, an electric current is supplied through wires (not shown) to the heating elements of anvils 15 and 43. When heating strips 17 and 47 are at an appropriate temperature, the electric current may be stopped. Handle 41 is raised to separate anvils 15 and 43. Then the ends of the irrigation drip tape to be spliced are placed together on heating strip 17 of anvil 15. Then, handle 41 is lowered to the position shown in FIG. 1. The force exerted on the irrigation drip tape between anvils 15 and 43 is controlled by the spring between first bracket 23 and second bracket 25. After an appropriate dwell time, handle 41 is lifted so that the spliced irrigation drip tape may be removed from tool 11.

1. A splicing tool, which comprises:
a base;
a first anvil supported by said base;
a post supported by said base;
a first bracket supported by said post;
a second bracket movably support with respect to said first bracket;
a spring disposed between said first bracket and said second bracket;
a plunger mechanism carried by said second bracket; and,
a second anvil carried by said plunger mechanism.

2. The splicing tool as claimed in claim 1, including:
means for adjusting force of said spring applied between said first bracket and said second bracket

3. The splicing tool as claimed in claim 2, wherein said means for adjusting said force of said spring includes:
an adjustment screw engaged with said first bracket; and,
a spring plate disposed between said adjustment screw and said spring.

4. The splicing tool as claimed in claim 1, including means for heating said first and second anvils.

5. The splicing tool as claimed in claim 1, including:
an operating handle coupled to said second bracket and said plunger.

6. The splicing tool as claimed in claim 5, including:
a linkage coupled between said operating handle and said plunger.

7. A splicing tool, which comprises:
a first heated anvil;
a second heated anvil; and,
means for moving said first heated anvil into contact with said second heated anvil to apply a force between said first and second heated anvils.

8. The splicing tool as claimed in claim 7, including:
means for adjusting the force applied between said first and second heated anvils.

9. The splicing tool as claimed in claim 7, wherein said means for adjusting the force between said first and second heated anvils includes a spring.

10. The splicing tool as claimed in claim 9, wherein said means for adjusting said force includes:
an adjustment screw engaging said spring.

11. The splicing tool as claimed in claim 9, including:
a base supporting said second heated anvil.

12. The splicing tool as claimed in claim 11, including:
a post supported by said base.

13. The splicing tool as claimed in claim 12, wherein said means for moving said first heated anvil into contact with said second heated anvil includes:
a plunger coupled to said post.

14. The splicing tool as claimed in claim 13, wherein said means for moving said first heated anvil into contact with said second heated anvil includes:
a first bracket coupled to said post;
a second bracket movably coupled to said first bracket, said plunger being coupled to said second bracket; and,
a spring compressed between said first bracket and said second bracket.

15. The splicing tool as claimed in claim 14, including:
means for adjusting the compression of said spring.

16. The splicing tool as claimed in claim 15, wherein said means for adjusting the compression of said spring includes
an adjustment screw coupled to said first bracket; and,
a spring plate disposed between said adjustment screw and said spring.

17. The splicing tool as claimed in claim 13, including:
an operator handle coupled to said second bracket and to said plunger.

18. The splicing tool as claimed in claim 17, including:
a linkage coupled between said operator handle and said plunger.
